(19) United States
(12) Patent Application Publication
(10) Pub. No.: US 2024/0257469 A1
(43) Pub. Date: Aug. 1, 2024

(54) SMART READING EXPERIENCE IN A VIRTUAL ENVIRONMENT

(71) Applicant: International Business Machines Corporation, Armonk, NY (US)

(72) Inventors: June-Ray Lin, Taipei City (TW); Ye Chuan Wang, Beijing (CN); Li Na Wang, Beijing (CN); Nan Chen, Beijing (CN); Ju Ling Liu, Beijing (CN)

(21) Appl. No.: 18/161,256

(22) Filed: Jan. 30, 2023

(51) Int. Cl. G06T 19/00; G06F 3/01; G06T 13/40

(52) U.S. Cl. CPC G06T 19/00; G06F 3/013; G06T 13/40; G06T 2219/004

(57) ABSTRACT

Embodiments of the invention are directed to a computer system that includes a processor electronically coupled to a memory. The processor is operable to perform processor operations that includes accessing hypertext virtual markup language encoded (HTVML-encoded) text. The HTVML-encoded text is displayed in an immersive video frame of a display of a virtual reality (VR) environment. HTVML content associated with the HTVML-encoded text is also displayed in the 360-degree video frame. The HTVML content include a three-dimensional (3D), immersive presentation format.

### BACKGROUND

The present invention relates in general to programmable computer systems operable to implement virtual reality (VR) environments. More specifically, the present invention relates to computing systems, computer-implemented methods, and computer program products operable to generate a VR environment having smart reading functionality operable to enable a smart reading experience for reading and interacting with text and text-related components of the VR environment.

Immersive videos or spherical videos (e.g., 360-degree videos, 180-degree video, and the like) are video recordings where a view in every direction (or in multiple directions) is recorded at the same time using, for example, an omnidirectional camera or a collection of cameras. An immersive video system can be implemented as a computer system operable to generate and display immersive video images, audio content, haptic feedback, text, and the like that simulate a real world experience. A person can enter and leave the simulated real world experience at any time using technology. The basic components of an immersive video system include a display; a computing system; and various feedback components that provide inputs from the user to the computing system.

### SUMMARY

Embodiments of the invention provide a computer system that includes a processor electronically coupled to a memory. The processor is operable to perform processor operations that includes accessing hypertext virtual markup language encoded (HTVML-encoded) text. The HTVML-encoded text is displayed in an immersive video frame of a display of a virtual reality (VR) environment. HTVML content associated with the HTVML-encoded text is also displayed in the immersive video frame. The HTVML content include a three-dimensional (3D), immersive presentation format.

Embodiments of the invention also provide computer-implemented methods and/or computer program products having substantially the same features as the computer system described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a block diagram illustrating a system according to embodiments of the invention;

FIG. 2 depicts details of a head-mounted-device (HMD) according to embodiments of the invention;

FIG. 3A depicts a block diagram illustrating additional details of a full 360-degree video frame according to embodiments of the invention;

FIG. 3B depicts a block diagram illustrating additional details of a full 360-degree video frame according to embodiments of the invention;

FIG. 4 depicts a block diagram illustrating an example of how portions of the system shown in FIG. 1 can be implemented according to embodiments of the invention;

FIG. 5A depicts an example of hypertext virtual markup language (HTVML) according to embodiments of the invention;

FIG. 5B depicts an example of HTVML-encoded text according to embodiments of the invention;

FIG. 6 depicts a block diagram illustrating an example of how portions of the system shown in FIG. 1 can be implemented according to embodiments of the invention;

FIG. 7 depicts a block diagram illustrating an example of how portions of the system shown in FIG. 1 can be implemented according to embodiments of the invention;

FIG. 8 depicts a block diagram illustrating how personalized comments can be generated according to embodiments of the invention;

FIG. 9A depicts a machine learning system that can be utilized to implement aspects of the invention;

FIG. 9B depicts a learning phase that can be implemented by the machine learning system shown in FIG. 9A; and

FIG. 10 depicts details of an exemplary computing environment operable to implement various aspects of the invention.

In the accompanying figures and following detailed description of the disclosed embodiments, the various elements illustrated in the figures are provided with three digit reference numbers. In some instances, the leftmost digits of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

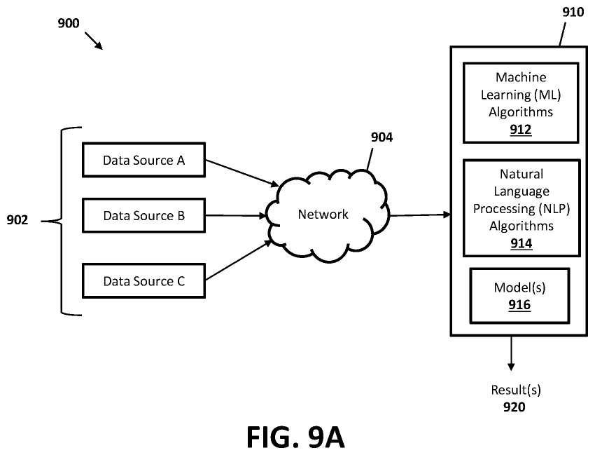

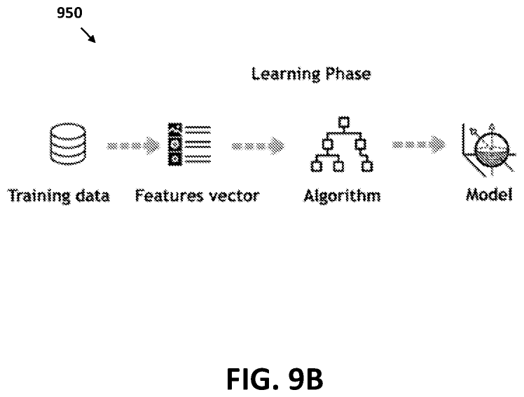

Many of the functional units of the systems described in this specification have been labeled as models. Embodiments of the invention apply to a variety of model implementations. In some embodiments of the invention, the models described herein can be implemented as machine learning algorithms and natural language processing algorithms configured and arranged to uncover unknown relationships between data/information and generate a model that applies the uncovered relationship to new data/information in order to perform an assigned task of the model. In some aspects of the invention, the models described herein can have all of the features and functionality of the models depicted in FIGS. 9A and 9B, which are described in greater detail subsequently herein.

Turning now to an overview of technologies that are relevant to and/or support aspects of the invention, as previously noted herein, immersive videos or spherical videos (e.g., 360-degree video, 180-degree video, and the like) are video recordings where a view in every direction (or in multiple directions) is recorded at the same time using, for example, an omnidirectional camera or a collection of cameras. An immersive video system can be implemented as a computer system operable to generate and/or display immersive video images, audio content, still photos, animations, text content, haptic feedback, and the like that simulate a real world experience. A person can enter and leave the simulated real world experience at any time using technology. The basic components of an immersive video system include a display; a computing system; and various feedback components that provide inputs from the user to the computing system. In some implementations, the display can be integrated within a head-mounted device (HMD) worn by the user and configured to deliver sensory impressions to the human senses (sight, sound, touch, smell, and the like) that mimic the sensory impressions that would be delivered to the human senses by the corresponding actual environment being displayed through the video. The type and the quality of these sensory impressions determine the level of immersion and the feeling of presence in the 360-degree video system. Other outputs provided by the HMD can include audio output and/or haptic feedback. The user can further interact with the HMD by providing inputs for processing by one or more components of the HMD. For example, the user can provide tactile inputs, voice commands, and other inputs while the HMD is mounted to the user's head.

The term “metaverse” describes a variety of VR environments, including highly immersive internet-based 3-D or virtually integrated environments. A metaverse environment can also be described as an online “place” where physical, virtual and augmented realities are shared. In an example implementation, activities of teams that need to collaborate to perform a task can, in theory, be performed by remotely-located collaborators meeting and performing collaboration activities in a metaverse environment. A metaverse collaboration environment could, if practically implemented as a replacement for a corresponding physical environment, save on power, space utilization, rent, and the ability to retain employees. VR headsets could further enhance the experience of a metaverse collaboration environment by incorporating 3D graphics (e.g., augmented reality), customizable dashboards, and other elements. The collaborators would not need to be in the same room if they are in the same “virtual space,” thus enabling them to collaborate even more effectively. The ability to virtually “travel” to various “places” in the metaverse could enable an operator to virtually visit any number of remote physical locations and interface efficiently with the systems at the remote physical locations.

Despite the potential benefits of performing collaboration activities in a VR (or metaverse) environment, there are challenges to realizing the above-described benefits of using VR/metaverse environments when performing semi-collaborative activities on-line communities of people how share a common experience. For example, a book discussion club is a group of people who meet to discuss a book or books that they have read and express their opinions, likes, dislikes, etc. Book discussion clubs meet in private homes, libraries, bookstores, online forums, pubs, in cafés, in restaurants, or over meals. Online forums are often informal and can involve members who have never met one another in person but have come together because of interest in a particular book, article, pamphlet, or a general subject covered by the book, article or pamphlet.

Current approaches to experiencing a writing and collaboratively sharing such experiences with other readers have not leveraged the full capabilities of VR (or metaverse environments). For example, text presented in a VR (or metaverse) environment is still largely a two-dimensional (2D) experience presented in a 3D immersive environment. In a common configuration, a virtual page is presented showing text, and a virtual keyboard is provided for manipulating the text on the page and performing interactive activities such as providing comments on an article or on a section of a book. Currently, there are no tools to assist a reader with having a true 3D immersive reading experience instead of simply using the 3D immersive VR environment to simulate the traditional 2D experience of reading an article/pamphlet/book on the display screen of a computing device.

Turning now to an overview of aspects of the invention, embodiments of the invention provide programmable computer systems operable to generate a VR environment having smart reading functionality operable to enable a smart reading experience for reading and interacting with text components of the VR environment. More specifically, embodiments of the invention provide computing systems, computer-implemented methods, and computer program products operable to encode text using a novel hypertext virtual markup language (HTVML). In accordance with aspect of the invention, the novel HTVML is a novel extension of hypertext markup language (HTML) that adds new text in the form of so-called “virtual” code that instructs a web browser to invoke a function that plays 3D immersive content associated with the HTVML-encoded text.

In general, HTML is a programming language used to describe the structure of information on a webpage. Together, HTML, CSS (cascading style sheets), and JavaScript make up the essential building blocks of websites worldwide, with CSS controlling a page's appearance and JavaScript programming controlling a page's functionality. HTML documents provide the bones of a webpage, while CSS provides the skin, and JavaScript provides the brains. A webpage can contain headings, paragraphs, images, videos, and many other types of data. Front-end developers use the HTML element to specify what kind of information each item on a webpage contains for instance, the “p” HTML element indicates a paragraph. Developers also write HTML language code to specify how different items relate to one another in the page's overall structure or document structure. A look under the hood of any website would reveal a basic HTML code page, which is written with an HTML structure editor. The HTML code page provides the structure for all the page's components, including its header element, footer element, main content, and other inline elements.

In accordance with aspects of the invention HTML code is extended in a novel manner to create HTVML code that includes so-called “virtual” code operable to invoke a function that will be used by a host server to implement 3D immersive content in the 3D immersive VR environment. In general immersive technology is any technology that extends reality or creates a new reality by leveraging immersive space (e.g., the 360-degree space, the 180-degree space, and the like). Because immersive technology leverages the 360-degree space/sphere and/or the 180-degree space/sphere, users (or viewers) can look in any direction (or in multiple directions) and see content.

In accordance with aspects of the invention, predetermined portions of the text are encoded as HTVML-encoded text based on a determination (e.g., by an HTVML encoder having machine learning functionality) that 3D immersive content is available for association with the text. For example, in a sentence that describes a “Gulf Stream,” the terms “Gulf stream” can be HTVML-encoded to, when prompted, call up a function that renders a 3D immersive Gulf Stream as the VR environment in which the text is displayed. In some embodiments of the invention, the HTVML-encoded text “Gulf Stream” operates as a link that calls up the above-described associated function when the link is, in effect, “clicked” in one form or another. In some embodiments of the invention, the function can be invoked automatically when the text is displayed. In some embodiments of the invention, the function can be invoked when the system detects that the text is being read by (or has been read by) the user/viewer, for example, by the detecting that the eye gaze of the viewer is on the text.

In some embodiments of the invention, in a sentence or a paragraph that takes a position on an issue such as “the greatest baseball player of all time,” the sentence/paragraph can be HTVML-encoded to, when prompted, call up a function that renders a 3D immersive rendering of comments that have been shared by others on the issue. For example, the 3D immersive rendering of a comment can be presented as an avatar of the person who made the comment, along with an audio presentation of the comment by the avatar, including appropriate gestures and facial expressions. In some embodiments of the invention, the 3D immersive rendering can be presented as avatars of multiple persons who made comments, along with an audio presentation of the comments by the avatar, including appropriate gestures and facial expressions. In some embodiments of the invention, the multiple comments can be analyzed using cognitive computing systems to convert the comments to a debate between the avatars with separate avatars representing different positions. For example, the cognitive computing system can analyze the comments and determine that the four most frequently discussed players in the comments are Babe Ruth, Ted Williams, Henry Aaron and Willie Mays. The cognitive computing system can generate an avatar for a proponent of each player and present the case for each player in the form of a debate between the avatars, where each avatar presents points in favor of a player and argues against the arguments in favor of other players. In some embodiments of the invention, the function that generates and presents the above-described 3D immersive debate can be invoked when the system detects that the sentence/paragraph is being read by (or has been read by) the user/viewer, for example, by the detecting that the eye gaze of the viewer is on the sentence/paragraph.

In embodiments of the invention, the cognitive computing systems can be implemented using a computer-based Q&A module operable to generate an answer to natural language questions that are either pre-set or presented by one or more of the designers. As a non-limiting example, the Q&A module can include all of the features and functionality of IBM© Watson© DeepQA. DeepQA is a Q&A system that can conduct an interrogation on any subject by applying elements of natural language processing, machine learning, information retrieval, hypothesis generation, hypothesis scoring, final ranking, and answer merging to arrive at a conclusion. Q&A systems such as IBM's DeepQA technology often use unstructured information management architecture (UIMA), which is a component software architecture for the development, discovery, composition, and deployment of multi-modal analytics for the analysis of unstructured information and its integration with search technologies developed by IBM. In some embodiments of the invention, the function can be invoked automatically when the sentence/paragraph is displayed.

In some embodiments of the invention, feedback is gathered from users/viewers related to positive and negative reactions to 3D immersive renderings presented to the user/viewer over time. In some embodiments of the invention, the 3D immersive rendering are presented as a form of a machine learning generated recommendation to the user. In some embodiments of the invention, the 3D immersive renderings can further include natural language processing (NLP) functionality that provides annotated explanations of why the 3D immersive rendering is being selected or recommended. In embodiments of the invention, the machine learning functionality can use the feedback to adjust the 3D rendering recommendations (e.g., by adjusting the annotations) to refine the recommendations and make them more personalized for the user who provided the feedback.

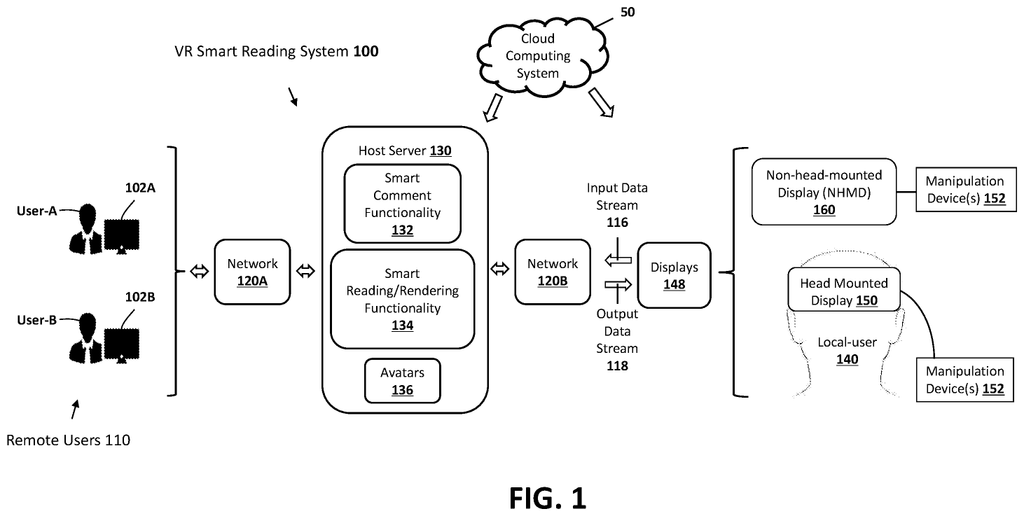

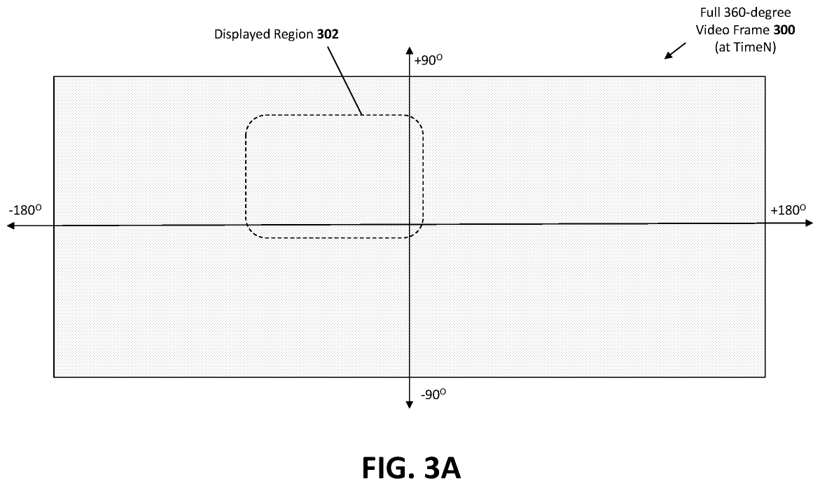

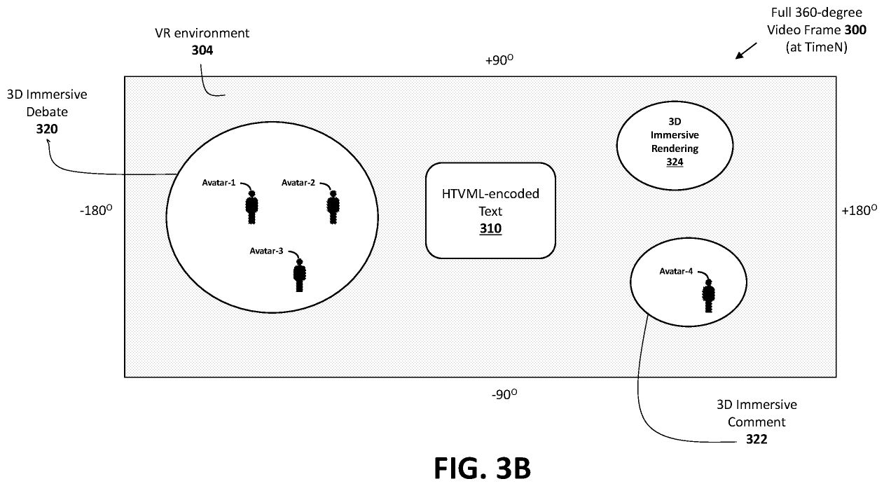

Turning now to a more detailed description of the aspects of the invention, FIG. 1 depicts a diagram illustrating a VR smart reading system 100 according to embodiments of the invention. In aspects of the invention, the system 100 is a 3D immersive video system that includes a host server 130 in communication with remote user terminals 102A, 102B and local terminals (or displays) 148 over networks 120A, 120B (e.g., the Internet). In some embodiment of the invention, the system 100 processes and displays immersive videos or spherical videos (e.g., 360-degree videos, 180-degree video, and the like), which are video recordings where a view in every direction (or in multiple directions) is recorded at the same time using, for example, an omnidirectional camera or a collection of cameras. The non-limiting example functionality of the system 100 described herein is described in connection with the use of 3D immersion rendering in the form of 360-degree renderings such as the full-frame 360-degree video 300 shown in FIG. 3A. However, embodiments of the invention apply to other forms of immersive video including for example 180-degree video.

Remote users 110, which are depicted as User-A and User-B, interface with the system 100 through remote user terminals 102A, 102B; and a local user(s) 140 interfaces with the system 100 using display 148. Although only two remote users 110 are shown any number of remote users 110 can be provided. In embodiments of the invention, the displays 148 and/or the remote terminals 102A, 102B can be implemented as a head mounted display (HMD) 150 or a non-HMD (NHMD) 160. The NHDM 160 can be a stand-alone flat panel display or a flat panel display integrated with another device such as a smartphone or a laptop. The HMD 150 is configured to be worn by the local user 140 (or the remote users 110). Both the HMD 150 and the NHMD 160 can be in wired or wireless communication with manipulation device(s) 152 (e.g., a three-dimensional mouse, data gloves, etc.) configured to be worn by and/or otherwise controlled/used by the local user 140 (and/or the remote users 110).

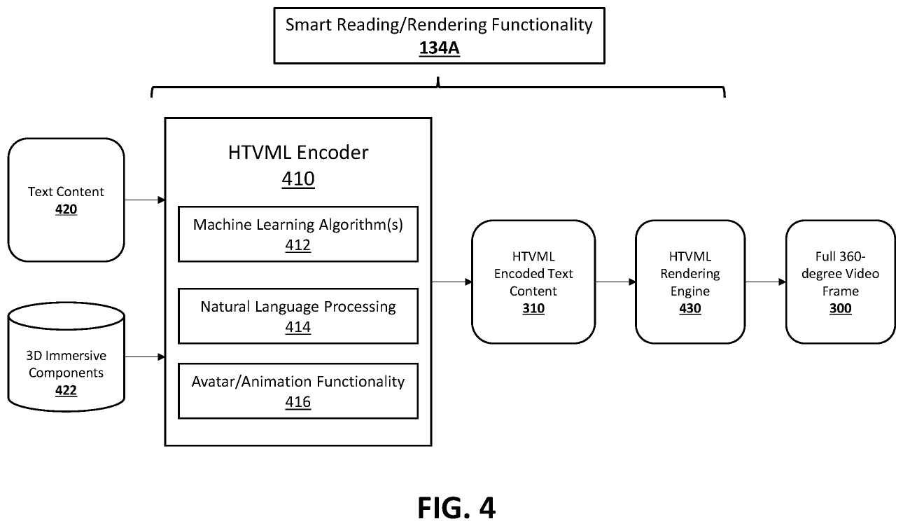

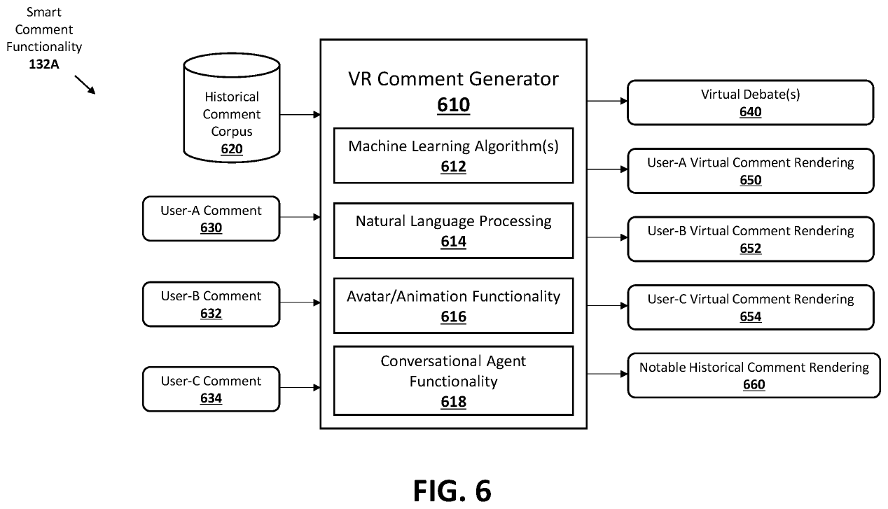

The host server 130 is in wired and/or wireless communication with the display(s) 148 and remote user terminals 102A, 102B. In embodiments of the invention, the host server 130 includes a full range of web server and/or web browser functionality (not shown separately from the host server 130). More specifically, the web server and/or web browser functionality is operable to read and decipher HTVML-encoded text, along with HTVML-encoded text in accordance with aspects of the invention. In accordance with aspects of the invention, the host server 130 further includes a smart comment functionality module 132, a smart reading/rendering functionality module 134, and an avatar generation module 136, configured and arranged as shown. In embodiments of the invention, the smart reading/rendering functionality module 134 is operable to encode text as HTVML-encoded text so the HTVML-encoded text can be read and used to call a function that renders 3D immersive renderings associated with the HTVML-encoded text. In embodiments of the invention, the smart comment functionality module 132 is operable to generate 3D immersive renders of comments in the form of individual comments, collective comments, and/or debates among different commentators. An example of how the smart reading/rendering functionality module 134 can be implemented as a smart reading/rendering functionality module 134A is depicted in FIG. 4 and described in greater detail subsequently herein. An example of how the smart comment functionality module 132 can be implemented as a VR comment generator 132A is depicted in FIG. 6 and described in greater detail subsequently herein.

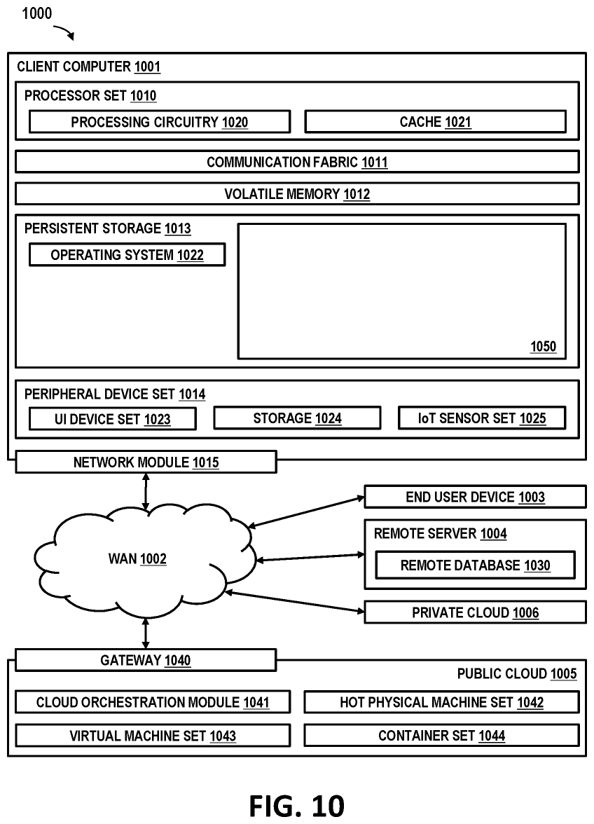

A cloud computing system 50 is in wired or wireless electronic communication with the system 100, and in particular with the host server 130. The cloud computing system 50 can supplement, support or replace some or all of the functionality (in any combination) of the system 100. Additionally, some or all of the functionality of the system 100 can be implemented as a node of the cloud computing system 50. Additional details of cloud computing functionality that can be used in connection with aspects of the invention are depicted by the computing environment 1000 shown in FIG. 10 and described in greater detail subsequently herein.

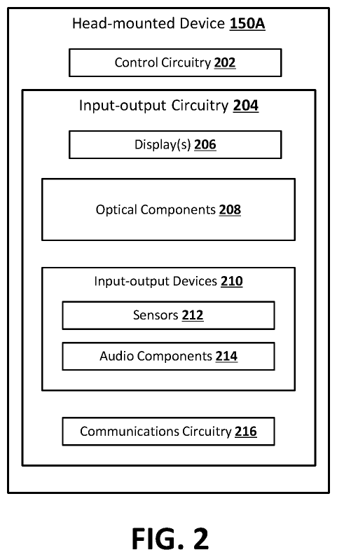

FIG. 2 depicts an HMD 150A, which is a non-limiting example of how the HMD 150 (shown in FIG. 1) can be implemented. In accordance with aspects of the invention, the HMD 150A includes control circuitry 202 and input-output circuitry 204, configured and arranged as shown. The input-output circuitry 204 includes display(s) 206, optical components 208, input-output devices 210, and communications circuitry 218, configured and arranged as shown. The input-output devices 210 include sensors 212 and audio components 214, configured and arranged as shown. The various components of the HMD 150A can be supported by a head-mountable support structure such as a pair of glasses; a helmet; a pair of goggles; and/or other head-mountable support structure configurations.

In embodiments of the invention, the control circuitry 202 can include storage and processing circuitry for controlling the operation of the HMD 150A. The control circuitry 202 can include storage such as hard disk drive storage, nonvolatile memory (e.g., electrically-programmable-read-only memory configured to form a solid-state drive), volatile memory (e.g., static or dynamic random-access-memory), etc. Processing circuitry in the control circuitry 202 can be based on one or more microprocessors, microcontrollers, digital signal processors, baseband processors, power management units, audio chips, graphic processing units, application specific integrated circuits, and other integrated circuits. Computer program instructions can be stored on storage in the control circuitry 202 and run on processing circuitry in the control circuitry 202 to implement operations for HMD 150A (e.g., data gathering operations, operations involving the adjustment of components using control signals, image rendering operations to produce image content to be displayed for a user, etc.).

The input-output circuitry 204 can be used to allow the HMD 150A to receive data from external equipment (e.g., the wall agent module 110 (shown in FIG. 1); a portable device such as a handheld device; a laptop computer; or other electrical equipment) and to allow the user 140 (shown in FIG. 1) to provide the HMD 150A with user input. The input-output circuitry 204 can also be used to gather information on the environment in which HMD 150A is operating. Output components in the input-output circuitry 204 can allow the HMD 150A to provide the user 140 with output and can be used to communicate with external electrical equipment.

Display(s) 206 of the input-output circuitry 204 can be used to display images (e.g., the full 360-degree video frame 300 (shown in FIG. 3B)) to the user 140 (shown in FIG. 1) of the HMD 150A. The display(s) 206 can be configured to have pixel array(s) to generate images that are presented to the user 140 through an optical system. The optical system can, if desired, have a transparent portion through which the user 140 (viewer) can observe real-world objects while computer-generated content is overlaid on top of the real-world objects by producing computer-generated images (e.g., the full 360-degree video frame 300) on the display(s) 206. In embodiments of the invention, the display(s) 206 are immersive views of the full 360-degree video frame 300, wherein the display(s) 206 place tiny screens and lenses close to the user's eyes to simulate large screens that encompass most of the user's field of view. As the user 140 performs actions like walking, head rotating (i.e., changing the point of view), data describing behavior of the user 140 (shown in FIG. 1) is fed to the computing system 110 (shown in FIG. 1) from the AMD 150A and/or the manipulation devices 152 (shown in FIG. 1).

The optical components 208 can be used in forming the optical system that presents images to the user 140. The optical components 208 can include static components such as waveguides, static optical couplers, and fixed lenses. The optical components 208 can also include adjustable optical components such as an adjustable polarizer, tunable lenses (e.g., liquid crystal tunable lenses; tunable lenses based on electro-optic materials; tunable liquid lenses; microelectromechanical system tunable lenses; or other tunable lenses), a dynamically adjustable coupler, and other optical devices formed from electro-optical materials (e.g., lithium niobate or other materials exhibiting the electro-optic effect). The optical components 208 can be used in receiving and modifying light (images) from the display 206 and in providing images (e.g., the full 360-degree video frame 300) to the user 140 for viewing. In some embodiments of the invention, one or more of the optical components 208 can be stacked so that light passes through multiple of the components 208 in series. In embodiments of the invention, the optical components 208 can be spread out laterally (e.g., multiple displays can be arranged on a waveguide or set of waveguides using a tiled set of laterally adjacent couplers). In some embodiments of the invention, both tiling and stacking configurations are present.

The input-output devices 210 of the input-output circuitry 204 are configured to gather data and user input and for supplying the user 140 (shown in FIG. 1) with output. The input-output devices 210 can include sensors 212, audio components 214, and other components for gathering input from the user 140 and/or or the environment surrounding the HMD 150A and for providing output to the user 140. The input-output devices 210 can, for example, include keyboards; buttons; joysticks; touch sensors for trackpads and other touch sensitive input devices; cameras; light-emitting diodes; and/or other input-output components. For example, cameras or other devices in the input-output circuitry 204 can face the eyes of the user 140 and track the gaze of the user 140. The sensors 212 can include position and motion sensors, which can include, for example, compasses; gyroscopes; accelerometers and/or other devices for monitoring the location, orientation, and movement of the HDM 150A; and satellite navigation system circuitry such as Global Positioning System (GPS) circuitry for monitoring location of the user 140. The sensors 212 can further include eye-tracking functionality. Using the sensors 212, for example, the control circuitry 202 can monitor the current direction in which a user's head is oriented relative to the surrounding environment. Movements of the user's head (e.g., motion to the left and/or right to track on-screen objects and/or to view additional real-world objects) can also be monitored using the sensors 212.

In some embodiments of the invention, the sensors 212 can include ambient light sensors that measure ambient light intensity and/or ambient light color; force sensors; temperature sensors; touch sensors; capacitive proximity sensors; light-based proximity sensors; other types of proximity sensors; strain gauges; gas sensors; pressure sensors; moisture sensors; magnetic sensors; and the like. The audio components 214 can include microphones for gathering voice commands and other audio input and speakers for providing audio output (e.g., ear buds, bone conduction speakers, or other speakers for providing sound to the left and right ears of a user). In some embodiments of the invention, the input-output devices 210 can include haptic output devices (e.g., vibrating components); light-emitting diodes and other light sources; and other output components. The input-output circuitry 204 can include wired and/or wireless communications circuitry 216 that allows the HMD 150A (e.g., using the control circuitry 202) to communicate with external equipment (e.g., remote controls, joysticks, input controllers, portable electronic devices, computers, displays, and the like) and that allows signals to be conveyed between components (circuitry) at different locations in the HMD 150A.

FIG. 3A depicts a full 360-degree video frame 300 generated by the host server 130. In embodiments of the invention, the host server 130 is configured and arranged to generate streaming video/image data and transmit the same over the networks 120A, 120B, along with local user behavior data and local user attribute data in input data stream 116 received from the user 140 (via display(s) 148) to generate the output data stream 118 and provide it to the display(s) 148. In embodiments of the invention, the displays 148 can be configured to support a function-API (application program interface) that allows a local user to input local user behavior data (e.g., adjust the displayed region 302 shown in FIG. 2B) to be input to the system 100 flexibly. In accordance with embodiments of the invention, the output data stream 118 includes the full 360-degree video frame 300 shown at a time denoted as TimeN. The full 360-degree video frame 300 is depicted in FIG. 3A as an equirectangular mapped 360-degree video frame where the yaw angle (−180 to +180 degrees) and the pitch angle (−90 to +90 degrees) are mapped to the x-axis and the y-axis, respectively. The full 360-degree video frame 300 can be a video recording where a view in every direction is recorded at the same time, shot using an omnidirectional camera or a collection of cameras. During playback on a normal flat display (e.g., the NHMD 160), the local user 140 has control of the viewing direction like a panorama. The full 360-degree video frame 300 can also be played on displays or projectors arranged in a sphere or some part of a sphere (not shown). The displayed region 302 (also known as the visible area or the user's viewpoint) of the full 360-degree video frame 300 can be displayed on the displays 148. In embodiments of the invention where the display 148 is incorporated within the HMD 150, immersive (i.e., 3D) views of the full 360-degree video frame 300 can be displayed to the local user 140 on a display (e.g., display 206 shown in FIG. 2) of the HMD 150, which places tiny screens and lenses close to the eyes of the local user 140 to simulate large screens. As the local user 140 performs actions like walking, head rotating (i.e., changing the point of view), data describing behavior of the local user 140 is fed through the input data stream 116 to the host server 130 from the HMD 150 and/or the manipulation devices 152. The host server 130 processes the information in real-time and generates appropriate feedback that is passed back to the user 140 by means of the output data stream 118.

FIG. 3B depicts a simplified example of a VR environment 304 that can be displayed to the remote users 110 and/or the local user 140 on the full 360-degree video frame 300 using the system 100 in accordance with aspects of the invention. The VR environment 304 displays a visual representation of the environment in which HTVML-encoded text 310 is presented or rendered. In some embodiments of the invention, what is placed as the VR environment 304 is determined by the HTVML-encoded text 310. In accordance with aspect of the invention, HTVML is extension of hypertext markup language (HTML) that adds new text in the form of so-called “virtual” code that instructs a web browser to invoke a function that plays 3D immersive content associated with the HTVML-encoded text 310.

In general, HTML is a programming language used to describe the structure of information on a webpage. Together, HTML, CSS (cascading style sheets), and JavaScript make up the essential building blocks of websites worldwide, with CSS controlling a page's appearance and JavaScript programming controlling a page's functionality. HTML documents provide the bones of a webpage, while CSS provides the skin, and JavaScript provides the brains. A webpage can contain headings, paragraphs, images, videos, and many other types of data. Front-end developers use the HTML element to specify what kind of information each item on a webpage contains for instance, the “p” HTML element indicates a paragraph. Developers also write HTML language code to specify how different items relate to one another in the page's overall structure or document structure. A look under the hood of any website would reveal a basic HTML code page, which is written with an HTML structure editor. The HTML code page provides the structure for all the page's components, including its header element, footer element, main content, and other inline elements.

In accordance with aspects of the invention HTML code is extended in a novel manner to create HTVML code that includes so-called “virtual” code operable to invoke a function that will be used by the host server 130 to implement 3D immersive content (e.g., VR environment 304, 3D immersive debate 320, 3D immersive comment 322, 3D immersive rendering 324) in the 3D immersive VR environment 304. In general immersive technology is any technology that extends reality or creates a new reality by leveraging the 360-degree space. Because immersive technology leverages the 360-degree space/sphere, users (or viewers) can look in any direction and see content.

In accordance with aspects of the invention, predetermined portions (or selected portions) of to-be-displayed text are encoded as HTVML-encoded text 310 based on a determination (e.g., by the HTVML encoder 410 (shown in FIG. 4) having machine learning functionality) that 3D immersive content is available for association with the to-be-encoded text. For example, in a sentence of the to-be-encoded text that describes a “Gulf Stream,” the terms “Gulf stream” can be HTVML-encoded to, when prompted, call up a function that renders a 3D immersive Gulf Stream as the VR environment 304 in which the HTVML text 310 is displayed. In some embodiments of the invention, the function can be invoked automatically when the HTVML-encoded text 310 is displayed. In some embodiments of the invention, the function can be invoked when the system 100 (specifically, the server 130) detects that the HTVML-encoded text 310 is being read by (or has been read by) the user/viewer (e.g., local user 110), for example, by the detecting that the eye gaze of the viewer is on the relevant portion (i.e., the term “Gulf Stream” in the HTVML-encoded text 310.

As another example, in a sentence or a paragraph of the HTVML-encoded text 310 that takes a position on an issue such as “the greatest baseball player of all time,” the sentence/paragraph can be HTVML-encoded to, when prompted, call up a function that renders a 3D immersive rendering of comments (e.g., 322, 320) that have been presented by others on the issue. For example, the 3D immersive rendering of a comment can be presented as an avatar (e.g., Avatar-1, Avatar-2, Avatar-3, and Avatar-4) of the person who made the comment, along with an audio presentation of the comment by the avatar, including appropriate gestures and facial expressions. In some embodiments of the invention, the 3D immersive comment 322 can be presented in a manner that simulates the person who made the comment speaking the comment directly to the local-user 140. In some embodiments of the invention, the 3D immersive rendering can be presented as avatars of multiple persons who made comments, along with an audio presentation of the comments by the avatar, including appropriate gestures and facial expressions. In some embodiments of the invention, the multiple comments can be analyzed using cognitive computing systems (e.g., the VR comment generator 610) to convert the comments to a debate (e.g., 3D immersive debate 320) between the avatars with separate avatars representing different positions. For example, the cognitive computing system can analyze the comments and determine that the most top three players discussed in the comments are Babe Ruth, Ted Williams, Henry Aaron and Willie Mays. The cognitive computing system can generate an avatar for each player and present the case for each player in the form of a debate between the avatars, where each avatar and present points in favor of a player and take argue against the arguments in favor of other players. In some embodiments of the invention, the 3D immersive debate 320 can be presented or rendered in a manner that simulates multiple persons having a debate, along with an audio presentation of the comment by each avatar, including appropriate gestures and facial expressions. In embodiments of the invention, the cognitive computing systems can be implemented using a computer-based Q&A module operable to generate an answer to natural language questions that are either pre-set or presented by one or more of the designers. As a non-limiting example, the Q&A module can include all of the features and functionality of a DeepQA technology developed by IBM. DeepQA is a Q&A system that can conduct an interrogation on any subject by applying elements of natural language processing, machine learning, information retrieval, hypothesis generation, hypothesis scoring, final ranking, and answer merging to arrive at a conclusion. Q&A systems such as IBM's DeepQA technology often use unstructured information management architecture (UIMA), which is a component software architecture for the development, discovery, composition, and deployment of multi-modal analytics for the analysis of unstructured information and its integration with search technologies developed by IBM. In some embodiments of the invention, the function can be invoked automatically when the sentence/paragraph is displayed. In some embodiments of the invention, the function can be invoked when the system detects that the sentence/paragraph is being read by (or has been read by) the user/viewer, for example, by the detecting that the eye gaze of the viewer is on the sentence/paragraph.

Embodiments of the invention are not limited to text that has been HTVML-encoded to render 3D immersive debates 320, VR environments 304, and a 3D immersive comment (or comments) 322. In some embodiments of the invention any type of 3D immersive rendering can be associated with the HTVML-encoded text 310, which is represented by the 3D immersive rendering 324 shown in FIG. 3B.

FIG. 4 depicts an example of how the smart reading/rendering functionality module 134 (shown in FIG. 1) can be implemented as a smart reading/rendering functionality module 134A in accordance with aspects of the invention. In embodiments of the invention, the smart reading/rendering functionality module 134A is operable to utilize an HTVML encoder 410 to encode text content 420 as HTVML-encoded text 310 so the HTVML-encoded text 310 can be read by an HTVML rendering engine 430 and used to call a function that renders 3D immersive renderings (e.g., 304, 320, 322, 324 shown in FIG. 3B) associated with the HTVML-encoded text 310 in a full 360-degree video frame 300. In embodiments of the invention, the HTVML-encoder 410 receives the text content 420, along with 3D immersive components 422, which includes the components elements used to form the 3D immersive renderings (e.g., 304, 320, 322, 324 shown in FIG. 3B). In embodiments of the invention, the HTVML encoder 410 include machine learning algorithms 412, natural language processing (NLP) functionality/algorithms 414, and avatar/animation functionality 416 that work in tandem to generate the video frame 300 (shown in FIG. 3B). The operations of the HTVML encoder 410 have been describe previously herein, and so, in the interest of brevity will not be repeated here.

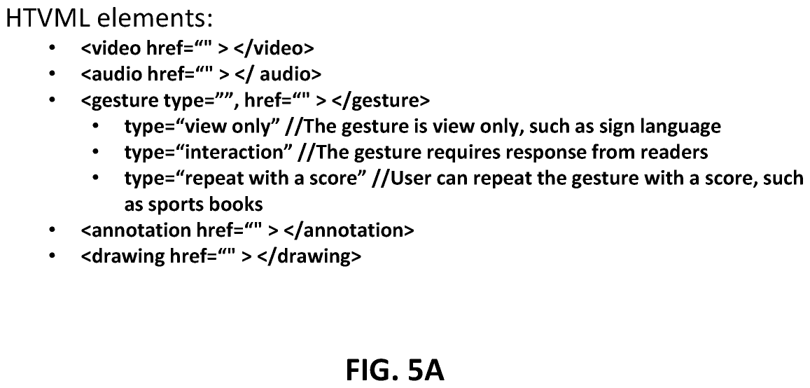

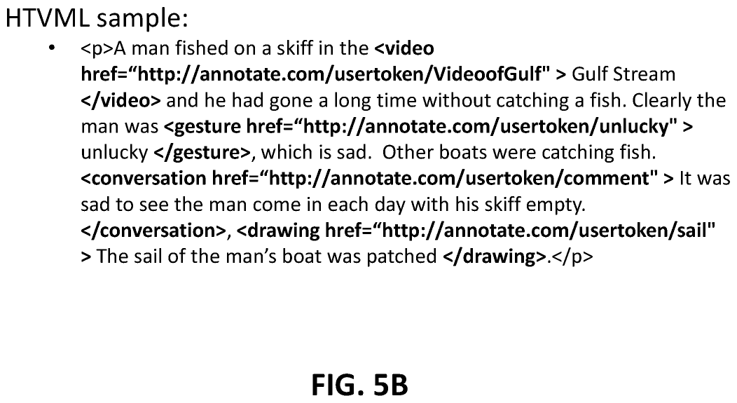

FIG. 5A depicts an example of how a format for HTVML elements can be configured to call up various functions that will generate and display various forms of 3D immersive content. In accordance with aspects of the invention, the 3D immersive presentation format includes any combination of audio, video, images, animation, and gestures. Similarly, FIG. 5B depicts an example of how the HTVML elements can be used to form HTVML-encoded text (e.g., HTVML-encoded text 310 shown in FIG. 4) according to embodiments of the invention.

FIG. 6 depicts a block diagram illustrating an example of how the smart comment functionality module 132 (shown in FIG. 1) can be implemented as a smart comment functionality system 132A having VR comment generator 610. The VR comment generator 610 is operable to generate 3D immersive rendering of comments in the form of individual comments, collective comments, and/or debates among different commentators (e.g., 322, 324 shown in FIG. 3B). As shown in FIG. 6, the VR comments generator 610 includes machine learning algorithms 612, natural language processing functionality/algorithms 614, avatar/animation functionality 616, and conversational agent functionality 618, configured and arranged as shown. The conversational agent functionality 618 can be used to generate features of a dialogue system or conversational agent (CA) or a “chatbot,” which is a computer system configured to communicate with a human or another chatbot using a coherent structure. CA systems can employ a variety of communication mechanisms, including, for example, text, speech, graphics, haptics, gestures, and the like for communication on both the input and output channels. In general, a CA system can be defined as a computer system configured to communicate with a human using a coherent structure. CA systems can employ a variety of communication mechanisms, including, for example, text, speech, graphics, haptics, gestures, and the like for communication on both the input and output channels. CA systems also employ various forms of natural language processing (NLP), which is a field of computer science, artificial intelligence, and computational linguistics concerned with the interactions between computers and humans using language.

As inputs, the VR comment generator 610 receives comment information from a historical comment corpus 620, a User-A comment 630, a User-B comment 632, and a User-C comment 634, configured and arranged as shown. As outputs, the VR comment generator 610 is operable to generate virtual debates 640, User-A virtual comment renderings 650, User-B virtual comment renderings 652, User-C virtual comment renderings 654, and notable historical comment renderings 660, configured and arranged as shown. In embodiments of the invention, the VR comment generator 610 can also receive comments generated by the current reader (e.g., local user 140), which can be included in the HTVML-generated text and provide as 3D immersive content to the local user 140 or to other users. The operations of the VR comments generator 610 have been describe previously herein, and so, in the interest of brevity will not be repeated here.

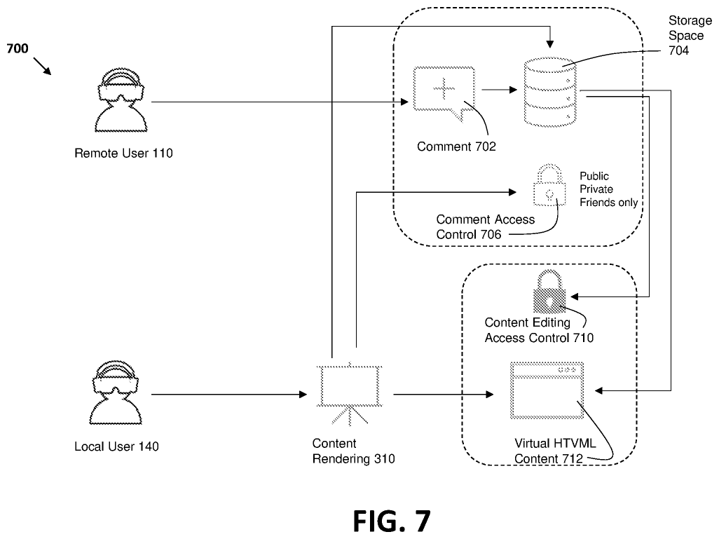

FIG. 7 depicts a system 700 in accordance with embodiments of the invention, in which each user 110, 140 has access to a storage space 704 to create and store comments 702. The storage space 704 then generates a link for the comment 702. The link is controlled by comment access control 708, which provides different access levels for others to access the comment 702, including public, private and friends only. The virtual HTVML comment 712 defines different access right so that user 110, 140 can add comment to the HTVML content 712 or not. If edit access is granted through content editing access control 710, the user 110, 140 can insert a comment link into a text position as a formatting element. Using the headset 150, 150A (shown in FIGS. 1 and 2), the rendering engine 430 (shown in FIG. 4) can view comment of other users 110, 140 in context. The comment link access right will be assessed so that only comments with access rights can be accessed.

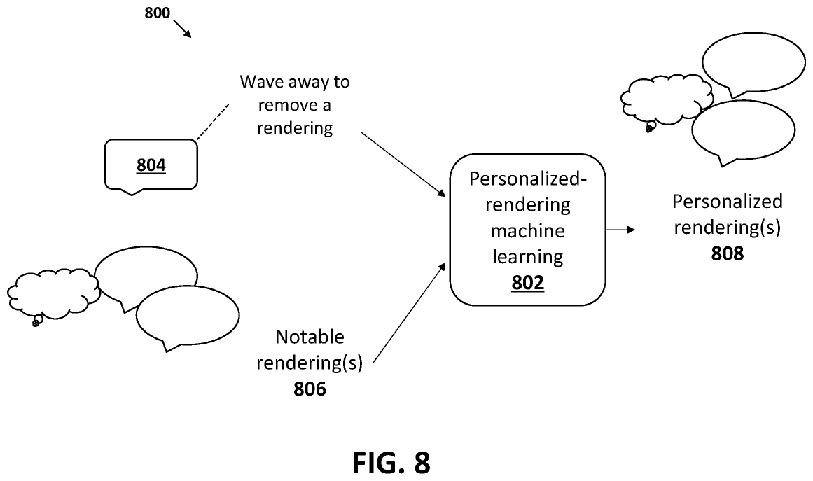

FIG. 8 depicts a block diagram illustrating how personalized renderings 808 (e.g., personalized version of the 3D immersive renderings 314, 320, 322 shown in FIG. 3B) can be generated according to embodiments of the invention. Users (e.g., local-user 140 shown in FIG. 1) can perform a “wave away” action in the VR smart reading system 100 (shown in FIG. 1) to wave away 3D immersive renderings 804 that the user finds uninteresting. Similarly, the user can read, view, or otherwise respond favorably to a 3D immersive rendering 804 that the user finds useful or interesting. A personalized-rendering machine learning module 802 can be incorporated within the system 100 and configured to learn from the user's positive and negative reactions to the 3D immersive renderings 804 and generate (and update) a set of personalized-renderings 808 (i.e., personalized 3D immersive renderings) for the user. In some embodiments of the invention, the 3D immersive rendering can be a notable rendering 806 sourced from or otherwise associated with a notable person or notable source. For example, the notable rendering 806 can be a comment from a notable person such as an expert in a particular field. In embodiments of the invention, notable renderings 806 are presented in a manner that conveys to the user the notable person/source. Notable renderings 806 enable the user to have access to the same reading experiences as the notable person/source associated with the notable renderings 806. In embodiments of the invention, the user can also provide positive and/or negative feedback on the notable renderings 806 so that the notable renderings 806 can be personalized to the user as well. In accordance with embodiments of the invention, the 3D immersive renderings 804 and the notable renderings 806 are presented to the personalized-rendering machine learning module 802 as a plurality of candidate HTVML content. The personalized-rendering machine learning module is trained, using the positive and negative feedback on the renderings 804, 806 provided by the user, to select from the candidate HTVML content the HTVML content that is included among the personalized renderings 808.

An example of machine learning techniques that can be used to implement aspects of the invention will be described with reference to FIGS. 9A and 9B. Machine learning models configured and arranged according to embodiments of the invention will be described with reference to FIG. 9A.

FIG. 9A depicts a block diagram showing a machine learning or classifier system 900 capable of implementing various aspects of the invention described herein. More specifically, the functionality of the system 900 is used in embodiments of the invention to generate various models and sub-models that can be used to implement computer functionality in embodiments of the invention. The system 900 includes multiple data sources 902 in communication through a network 904 with a classifier 910. In some aspects of the invention, the data sources 902 can bypass the network 904 and feed directly into the classifier 910. The data sources 902 provide data/information inputs that will be evaluated by the classifier 910 in accordance with embodiments of the invention. The data sources 902 also provide data/information inputs that can be used by the classifier 910 to train and/or update model(s) 916 created by the classifier 910. The data sources 902 can be implemented as a wide variety of data sources, including but not limited to, sensors configured to gather real time data, data repositories (including training data repositories), and outputs from other classifiers. The network 904 can be any type of communications network, including but not limited to local networks, wide area networks, private networks, the Internet, and the like.

The classifier 910 can be implemented as algorithms executed by a programmable computer such as a computing environment 1000 (shown in FIG. 11). As shown in FIG. 9A, the classifier 910 includes a suite of machine learning (ML) algorithms 912; natural language processing (NLP) algorithms 914; and model(s) 916 that are relationship (or prediction) algorithms generated (or learned) by the ML algorithms 912. The algorithms 912, 914, 916 of the classifier 910 are depicted separately for ease of illustration and explanation. In embodiments of the invention, the functions performed by the various algorithms 912, 914, 916 of the classifier 910 can be distributed differently than shown. For example, where the classifier 910 is configured to perform an overall task having sub-tasks, the suite of ML algorithms 912 can be segmented such that a portion of the ML algorithms 912 executes each sub-task and a portion of the ML algorithms 912 executes the overall task. Additionally, in some embodiments of the invention, the NLP algorithms 914 can be integrated within the ML algorithms 912.

The NLP algorithms 914 include speech recognition functionality that allows the classifier 910, and more specifically the ML algorithms 912, to receive natural language data (text and audio) and apply elements of language processing, information retrieval, and machine learning to derive meaning from the natural language inputs and potentially take action based on the derived meaning. The NLP algorithms 914 used in accordance with aspects of the invention can also include speech synthesis functionality that allows the classifier 910 to translate the result(s) 920 into natural language (text and audio) to communicate aspects of the result(s) 920 as natural language communications.

The NLP and ML algorithms 914, 912 receive and evaluate input data (i.e., training data and data-under-analysis) from the data sources 902. The ML algorithms 912 includes functionality that is necessary to interpret and utilize the input data's format. For example, where the data sources 902 include image data, the ML algorithms 912 can include visual recognition software configured to interpret image data. The ML algorithms 912 apply machine learning techniques to received training data (e.g., data received from one or more of the data sources 902) in order to, over time, create/train/update one or more models 916 that model the overall task and the sub-tasks that the classifier 910 is designed to complete.

Referring now to FIGS. 9A and 9B collectively, FIG. 9B depicts an example of a learning phase 950 performed by the ML algorithms 912 to generate the above-described models 916. In the learning phase 950, the classifier 910 extracts features from the training data and coverts the features to vector representations that can be recognized and analyzed by the ML algorithms 912. The features vectors are analyzed by the ML algorithm 912 to “classify” the training data against the target model (or the model's task) and uncover relationships between and among the classified training data. Examples of suitable implementations of the ML algorithms 912 include but are not limited to neural networks, support vector machines (SVMs), logistic regression, decision trees, hidden Markov Models (HMMs), etc. The learning or training performed by the ML algorithms 912 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier 910 and the ML algorithms 912. Unsupervised learning can utilize additional learning/training methods including, for example, clustering, anomaly detection, neural networks, deep learning, and the like.

When the models 916 are sufficiently trained by the ML algorithms 912, the data sources 902 that generate “real world” data are accessed, and the “real world” data is applied to the models 916 to generate usable versions of the results 920. In some embodiments of the invention, the results 920 can be fed back to the classifier 910 and used by the ML algorithms 912 as additional training data for updating and/or refining the models 916.

In aspects of the invention, the ML algorithms 912 and the models 916 can be configured to apply confidence levels (CLs) to various ones of their results/determinations (including the results 920) in order to improve the overall accuracy of the particular result/determination. When the ML algorithms 912 and/or the models 916 make a determination or generate a result for which the value of CL is below a predetermined threshold (TH) (i.e., CL<TH), the result/determination can be classified as having sufficiently low “confidence” to justify a conclusion that the determination/result is not valid, and this conclusion can be used to determine when, how, and/or if the determinations/results are handled in downstream processing. If CL>TH, the determination/result can be considered valid, and this conclusion can be used to determine when, how, and/or if the determinations/results are handled in downstream processing. Many different predetermined TH levels can be provided. The determinations/results with CL>TH can be ranked from the highest CL>TH to the lowest CL>TH in order to prioritize when, how, and/or if the determinations/results are handled in downstream processing.

In aspects of the invention, the classifier 910 can be configured to apply confidence levels (CLs) to the results 920. When the classifier 910 determines that a CL in the results 920 is below a predetermined threshold (TH) (i.e., CL<TH), the results 920 can be classified as sufficiently low to justify a classification of “no confidence” in the results 920. If CL>TH, the results 920 can be classified as sufficiently high to justify a determination that the results 920 are valid. Many different predetermined TH levels can be provided such that the results 920 with CL>TH can be ranked from the highest CL>TH to the lowest CL>TH.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 10 depicts an example computing environment 1000 that can be used to implement aspects of the invention. Computing environment 1000 contains an example of an environment for the execution of at least some of the computer code involved in performing the inventive methods, such as the improved user experience in a VR environment using a novel smart reading experience 1050. In addition to block 1050, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1050, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1050 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in block 1050 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” and variations thereof are used herein to mean “serving as an example, instance or illustration.” Any embodiment or design described herein as “exemplary” is not necessarily to be construed as preferred or advantageous over other embodiments or designs. The terms “at least one,” “one or more,” and variations thereof, can include any integer number greater than or equal to one, i.e. one, two, three, four, etc. The terms “a plurality” and variations thereof can include any integer number greater than or equal to two, i.e., two, three, four, five, etc. The term “connection” and variations thereof can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The phrases “in signal communication”, “in communication with,” “communicatively coupled to,” “electronically coupled to” and variations thereof can be used interchangeably herein and can refer to any coupling, connection, or interaction using electrical signals to exchange information or data, using any system, hardware, software, protocol, or format, regardless of whether the exchange occurs wirelessly or over a wired connection.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A computer system comprising a processor electronically coupled to a memory, wherein the processor performs processor operations comprising:
accessing hypertext virtual markup language encoded (HTVML-encoded) text;
displaying the HTVML-encoded text in an immersive video frame of a display of a virtual reality (VR) environment; and
displaying in the immersive video frame HTVML content associated with the HTVML-encoded text, wherein the HTVML content comprises a three-dimensional (3D), immersive presentation format.

2. The computer system of claim 1, wherein the HTVML content comprises a simulation of a person providing a comment.

3. The computer system of claim 1, wherein the HTVML content comprises a simulation of multiple persons having a debate.

4. The computer system of claim 1, wherein the HTVML content comprises a rendering of the VR environment.

5. The computer system of claim 1, wherein displaying in the immersive video frame the HTVML content associated with the HTVML-encoded text is initiated by detecting an eye gaze of a viewer on a predetermined portion of the HTVML-encoded text.

6. The computer system of claim 1, wherein the processor operations further comprise:
receiving, using a machine learning algorithm, a plurality of candidate HTVML content; and
selecting, using the machine learning algorithm, the HTVML content from the plurality of candidate HTVML content based at least in part on feedback from a viewer of the immersive video frame.

7. The computer system of claim 1, wherein the 3D, immersive presentation format comprises any combination of audio, video, images, animation, and gestures.

8. A computer-implemented method comprising:
accessing, using a processor system, hypertext virtual markup language encoded (HTVML-encoded) text;
using the processor system to display the HTVML-encoded text in an immersive video frame of a display of a virtual reality (VR) environment; and
using the processor system to display in the immersive video frame HTVML content associated with the HTVML-encoded text, wherein the HTVML content comprises a three-dimensional (3D), immersive presentation format.

9. The computer-implemented method of claim 8, wherein the HTVML content comprises a simulation of a person providing a comment.

10. The computer-implemented method of claim 8, wherein the HTVML content comprises a simulation of multiple persons having a debate.

11. The computer-implemented method of claim 8, wherein the HTVML content comprises a rendering of the VR environment.

12. The computer-implemented method of claim 8, wherein using the processor system to display in the immersive video frame the HTVML content associated with the HTVML-encoded text is initiated by the processor system detecting an eye gaze of a viewer on a predetermined portion of the HTVML-encoded text.

13. The computer-implemented method of claim 8, wherein the processor operations comprise:
receiving, using a machine learning algorithm, a plurality of candidate HTVML content; and
selecting, using the machine learning algorithm, the HTVML content from the plurality of candidate HTVML content based at least in part on feedback from a viewer of the immersive video frame.

14. The computer-implemented method of claim 8, wherein the 3D, immersive presentation format comprises any combination of audio, video, images, animation, and gestures.

15. A computer program product comprising a computer readable program stored on a computer readable storage medium, wherein the computer readable program, when executed on a processor system, causes the processor system to perform processor operations comprising:
accessing hypertext virtual markup language encoded (HTVML-encoded) text;
displaying the HTVML-encoded text in an immersive video frame of a display of a virtual reality (VR) environment; and
displaying in the immersive video frame HTVML content associated with the HTVML-encoded text, wherein the HTVML content comprises a three-dimensional (3D), immersive presentation format comprising any combination of audio, video, images, animation, and gestures.

16. The computer program product of claim 15, wherein the HTVML content comprises a simulation of a person providing a comment.

17. The computer program product of claim 15, wherein the HTVML content comprises a simulation of multiple persons having a debate.

18. The computer program product of claim 15, wherein the HTVML content comprises a rendering of the VR environment.

19. The computer program product of claim 15, wherein displaying in the immersive video frame the HTVML content associated with the HTVML-encoded text is initiated by detecting an eye gaze of a viewer on a predetermined portion of the HTVML-encoded text.

20. The computer program product of claim 15, wherein the processor operations further comprise:
receiving, using a machine learning algorithm, a plurality of candidate HTVML content; and
selecting, using the machine learning algorithm, the HTVML content from the plurality of candidate HTVML content based at least in part on feedback from a viewer of the immersive video frame.
